(19) United States
(12) Patent Application Publication
(10) Pub. No.: US 2011/0109801 A1
(43) Pub. Date: May 12, 2011

(54) Method and System for Television Channel Control

(76) Inventors: Christopher L. Thomas, Madison, AL (US); Douglas E. Pritchett, Huntsville, AL (US); William R. Lazenby, JR., Madison, AL (US); Michael L. Potter, Huntsville, AL (US)

(21) Appl. No.: 12/617,415

(22) Filed: Nov. 12, 2009

(51) Int. Cl. H04N 5/50; H04N 5/45

(52) U.S. Cl. 348/565; 348/731; 348/E05.097; 348/E05.112

(57) ABSTRACT

Methods and systems are provided to switch television channels during a commercial break and automatically notify the viewer when the commercial on the original channel is over so that the user may switch back to watch the original channel. This permits a viewer to avoid commercials during live television while maximizing the viewing of desired content on the original channel. A television channel selection device includes two independent tuners. In normal operation, a first tuner provides channel-selected signals to a television. When a viewer sees a commercial, the system begins a process employing a second independent tuner to internally monitor the first tuner signal until the termination of the commercial is detected. In the meantime, the first tuner provides channel-selected signals so that the viewer may view other channels. The viewer is notified of the end of the commercials by one of a variety of notification techniques.

This generally relates to televisions and more particularly to channel controllers for televisions.

### BACKGROUND

Television signal processing is used to switch or tune between channels in order to display audio/visual content on a display. Today, television signals may be sourced by over-the-air antennae, coaxial cables, satellite receivers, fiber optic cables, wired or wireless network, the Internet or telephone wires, but are not limited to these television signal sources or source types. Television signals may include multiple-channel audio/visual content containing programming and commercials. Any channel-selectable source of video containing programming content and commercials is included within the meaning of “television” as used herein.

As stated, televisions receive programming content that includes both programming and commercials. The commercials are employed as part of the compensation model for the television signal provider. Usually, the programming is desirable to the viewer and the commercials are not. When a program is interrupted for commercials, viewers frequently change the channel for a period of time until they believe that the programming on their original channel is resumed. This is sometimes referred to as channel-surfing, and involves the practice of changing channels in order to avoid commercials and maximize the time spent watching the desirable portion of the television content, namely the programming.

Conventional systems exist for reading recorded television video signals and discerning the start and stop points of the commercial content versus the programming content. For example, MythTV sells personal video recorders that segregate commercials from programming content in recorded video. ReplayTV, Inc. also sold personal video recorders, e.g., ReplayTV DVR 4000 series, that employed automatic commercial skipping in recorded video. MythTV employs three clues that the digital processor uses to identify the occurrence of commercial content. Those include (1) testing for a blank frame (blank frames occur between programming content and commercials), (2) identifying rapid scene transitions (scene transitions occur more frequently and in closer time proximity during commercials), and (3) testing for digital-on-screen graphics (programming content, but not commercial content, usually contains “bugs” or digitally added symbols in a corner of the display to advertise the content provider). Using any one, two or three of the above in combination can provide a good indication of content that is commercial versus programming. Other mechanisms for distinguishing commercial content from programming content are also suitable.

However, these systems do not typically address problems associated with commercials and live television watching, for example. Accordingly, there is a desire for a method and system that allows users to avoid commercials during live television watching while maximizing the time of viewing desired content programming.

### SUMMARY

Methods and systems are provided to switch television channels during a commercial break and automatically notify or automatically return the viewer to the original channel when the commercial on the original channel is over. In accordance with methods and systems consistent with the present invention, a data processing system is provided for controlling a television to assist returning to a television channel at an end of a commercial, comprising a first tuner configured to receive multiple channels of television content, and a second tuner configured to receive the multiple channels of television content. The data processing system further comprises a controller configured to receive a first channel from the first tuner, output the first channel from the first tuner to a display, and set the second tuner to the first channel. The controller is further configured to change the first tuner to one or more other channels, output the one or more other channels to the display, and notify a user of an end of a commercial in response to the detection of the end of the commercial by a processor. The data processing system further comprises a processor configured to monitor the first channel from the second tuner for the end of the commercial, and detect the end of the commercial on the first channel from the second tuner.

In one implementation, a method in a data processing system is provided for controlling a television to assist returning to a television channel at an end of a commercial, comprising displaying a first channel with a first tuner, setting a second tuner to the first channel, and changing the first tuner to one or more other channels. The method further comprises monitoring the first channel from the second tuner for an end of a commercial, detecting the end of the commercial on the first channel from the second tuner, and notifying a user of the end of the commercial in response to the detection of the end of the commercial.

In another implementation, a method in a data processing system is provided for controlling a television to assist returning to a television channel at an end of a commercial, comprising automatically monitoring television content on a first channel for an end of a commercial while displaying a second channel different from the first channel to a user. The method further comprises automatically detecting the end of the commercial on the first channel, and providing notification of the end of the commercial on the first channel to the user in response to the automatic detection of the end of the commercial.

### BRIEF DESCRIPTION OF THE DRAWINGS

FIG. 1 shows exemplary components of an exemplary system in accordance with methods and systems consistent with the present invention.

FIG. 2 depicts a flowchart of an exemplary method of operation of the processor and controller in FIG. 1.

### DETAILED DESCRIPTION

Methods and systems in accordance with the present invention allow a user to switch channels during a commercial break and automatically notify the user when the commercial on the original channel is over so that the user may switch back to watch the original channel. Alternatively, they automatically switch the television back to the original channel when the commercial is over. These systems intelligently manage commercial interruptions by providing a system that enhances the viewer's return to an original channel when channel surfing. This permits a user to avoid commercials while watching live television, for example, while maximizing the viewing of the desired content on the original channel. The channel controller allows a user to enter a “smart surf” mode in which the viewer can surf other channels while an original channel is being monitored internally for the conclusion of its commercials.

In the smart surf mode, an original television tuner provides programming content until a commercial is seen by the viewer. When the commercial arrives, the viewer uses a remote control (or other input device) to enter the smart surf mode. The smart surf mode activates a second, independent television tuner receiving the same television source input as the original tuner. The second tuner automatically begins feeding the television signal to the television so the viewer can surf any channels desired using the second tuner. Meanwhile, the original tuner continues outputting the original channel signal, which is tested by circuitry internally for a conclusion in the commercial break. When the commercial break in the original tuner signal is determined to conclude and the programming is returning on the original channel, the system automatically alerts the viewer by one or more of a series of potential channel-returning initiatives. The viewer can then be prompted to return to the original channel without missing any of the desired programming but missing all, or essentially all, of the commercial programming.

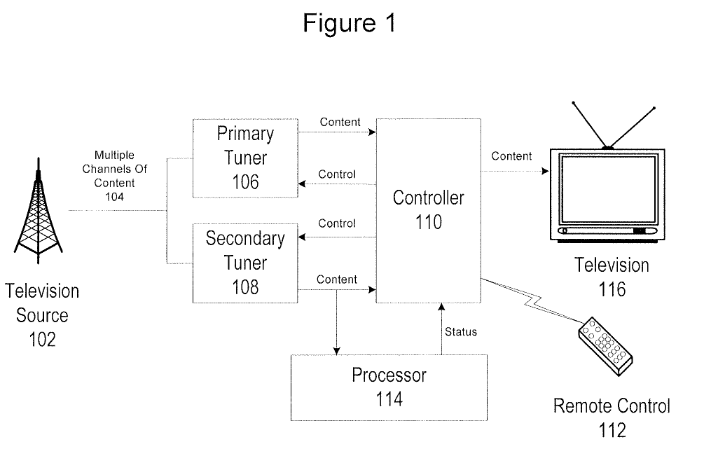

FIG. 1 shows exemplary components of an exemplary system in accordance with methods and systems consistent with the present invention. Television signals are obtained from a television source 102. The source 102 can be an over-the-air antenna or any number of analog or digital television signal providers such as cable, satellite, fiber optic, internet, etc. Television signals can be standard format RF signals containing video, audio, and control content that are delivered via the over-the-air, cable, satellite, Internet, wired or wireless network or other delivery mechanism. The signals may also be other types of signals. The RF signals are provided on a variety of channels with a variety of corresponding contents. Television tuners are used to receive and convert the RF signals into audio and video signals that are used to produce sound and pictures on the display. Different tuners use different standard formats, such as PAL, NTSC, ATSC, DVB, etc. Television tuner circuits of various types are well known and are commercially available off-the-shelf.

The television source 102 thus provides multiple channels of content 104 over each frequency band or channel. The television source 102 is connected to a primary tuner 106 and a secondary tuner 108 (alternatively, the source can be switched between or to both of the tuners as needed). The primary tuner 106 and the secondary tuner 108 operate under the control of a controller 110 via control lines. The controller 110 may be hardware or software or any combination of hardware and software. Content is provided from the primary tuner 106 and the secondary tuner 108 to the controller 110 via content lines. The controller 110 also receives IR signals from a remote control 112 and status signals from a processor 114 that identifies commercials described below. The processor 114 receives the content signals from the secondary tuner 108 (or alternatively, from the controller 110, which receives them from the secondary tuner 108). Although shown outside the controller 110, the processor 114 may reside inside the controller 110 as part of the controller. The controller 110 delivers selected content from one or both of the primary and secondary tuners 106-108 to the television 116. Television 116 can be any type of video display device capable of rendering television signals.

In FIG. 1, the apparatus thus includes two television tuners (106 and 108), a processor 114 and a controller 110. Both the primary tuner 106 and the secondary tuner 108 are capable of selecting a unique channel of television signal content from the multiple channels of content 104. The processor 114 is responsible for analyzing the content supplied by the secondary tuner 108 to identify the presence of commercials and to convey that information to the controller 110. The controller 110 supplies selected content to the television 116. That content can be the content passed from the primary tuner 106, the content passed from the secondary tuner 108, combinations of both contents from the primary tuner 106 and the secondary tuner 108, and internally-generated menus and displays (with or without the content from the tuners). The controller 110 also receives and handles control instructions from the television viewer via the remote control 112 or other user input device (not shown) and intelligently controls the primary tuner and secondary tuner channel selections.

FIG. 1 shows hardware for automating and/or enhancing a return to an originally-viewed channel during channel surfing. As used herein, the term “smart surfing” will be used as a shorthand term to describe a system that assists a user in returning to an original channel once commercials are finished on the original channel. Unless otherwise noted, the primary tuner 106 is available for tuning the multiple channels of content 104 to a desired channel for viewing on the television 116. The channel of the primary tuner 106 can be changed by a user operating the remote control 112. Normal operations of a television and television tuner can be performed using the primary tuner 106 and television 116, such as channel selection, picture-in-picture (allowing one channel to be viewed full-screen and another channel to be viewed in a window) and picture-by-picture (allowing two channels to be simultaneously viewed side-by-side on the screen).

Smart surfing is activated by the viewer/user when a commercial break is encountered on a desired channel. This is typically done by pressing an associated button on the remote control 112. Also, in another implementation, the system may begin automatic notification or switching of the viewing channel when it detects that a commercial has begun. When activated, the smart surfing allows the viewer to channel surf using the primary tuner 106 while the controller 110 awaits a conclusion of commercials on the original channel. During that waiting period, the secondary tuner 108 is automatically tuned to the original channel, and the commercials of the original content on that channel are monitored by the processor 114 to determine when they conclude (and desirable programming content resumes).

When prompted by the processor 114 on the status line that the commercials have ended on the original channel, the controller 110 can provide an audio and/or visual indication to the viewer that the commercial break has concluded on the original channel. Alternatively, the controller 110 can automatically change the primary tuner 106 back to the original channel when the processor 114 (reading the original channel from the secondary tuner 108) determines that the commercials have concluded. When the audio/visual indicator is used, the indicator can remain for a duration to allow the viewer time to abort the smart surf mode and resume watching the original channel through the primary tuner 106. That duration can be varied to allow the viewer time to abort the smart surf mode.

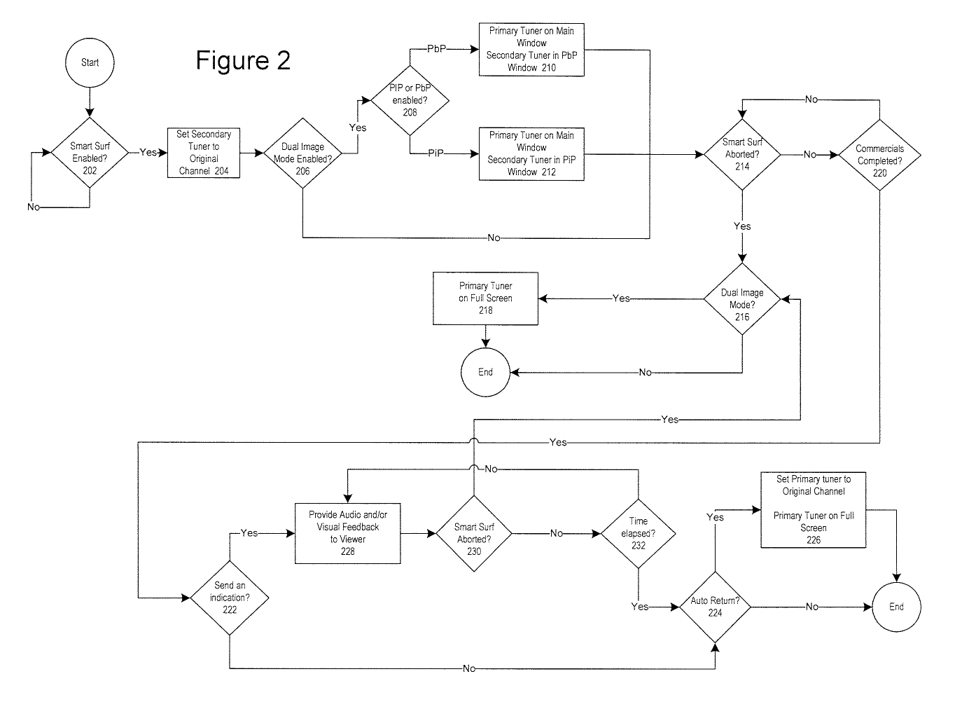

FIG. 2 depicts a flowchart of an exemplary method of operation of the controller 110 and processor 114 in FIG. 1. First, the controller 110 determines whether the smart surf mode is activated by the user, for example, by operation of the remote control 112 (step 202). In one implementation, this mode may be activated automatically by the controller 110 by sensing the beginning of a commercial. If the smart surf mode is enabled, the controller 110 changes the secondary tuner 108 to the original channel that was being displayed by the primary tuner 106 and viewed by the user (step 204). In one alternative implementation, however, the primary tuner 106 may be left on the original channel and monitored while the secondary tuner 108 is viewed by the user.

Then, the system determines if a dual image mode has been selected by the user, e.g., to view the original window in a picture-in-picture or picture-by-picture mode while surfing other channels during a commercial break (step 206). If the dual image mode is not selected, the processor 114 continues monitoring the completion of the commercial as described further below. If dual image mode is selected, the system determines whether picture-in-picture or picture-by-picture has been selected (step 208). If picture-by-picture is selected, the controller 110 displays the primary tuner's signal content in the main window and the secondary tuner's signal content in the picture-by-picture window (step 210). However, if picture-in-picture is selected, the controller 110 displays the primary tuner 106 signal content in the main window while displaying the secondary tuner's signal content in the picture-in-picture window (step 212).

The controller 110 monitors whether the user has deactivated the smart surf mode (step 214), and if so, aborts smart surf mode, returning the viewing to the original channel on the primary tuner 106. If dual image mode was activated (step 216), the primary tuner 106 is returned to the full screen (step 218), and the process ends until smart surf mode is enabled again.

If smart surf mode is active, the processor 114 monitors the contents of this secondary tuner 108 to determine if the commercials have completed (step 220). If the commercials have not completed, the processor 114 monitors the secondary tuner 108 for the completion of the commercials until the commercials are completed or smart surf mode has been aborted. When the commercials are complete, the controller 110 determines whether it is to send an indication to the viewer (step 222). If it is not to send an indication to the viewer, the controller 110 determines if it is to automatically return viewing to the original channel (step 224). If it is to return to the original channel automatically, the controller 110 sets the primary tuner 106 to the original channel on the full screen (step 226).

If the system is set to indicate to the user when the commercials are completed, the controller 110 provides audio and/or visual feedback to the viewer for a duration of time (step 228). Once again, the controller 110 monitors whether the smart surf mode is aborted by the user after receiving this feedback (step 230). If the user aborts the smart surf mode to return the viewing to the original channel, the controller 110 aborts the mode as described above, returning the viewing to the original channel on the primary tuner 106. If dual image mode was activated (step 216), the primary tuner 106 is returned to the full screen (step 218), and the process ends until smart surf mode is enabled again. If smart surf mode is not aborted by the user, the controller 110 determines if the duration of time to display the feedback has expired (step 232). If the time is not expired, the controller 110 continues to display the visual and/or audio feedback to the viewer (step 228).

Once the time has expired and smart surf is not aborted by the user, the controller 110 determines if it is to automatically return to the original channel (step 224). If it is to return to the original channel automatically, the controller 110 sets the primary tuner 106 to the original channel on the full screen (step 226). If not, the controller 110 allows the viewer to continue viewing the channel he or she has selected on the primary tuner 106.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A data processing system for controlling a television to assist returning to a television channel at an end of a commercial, comprising:
a first tuner configured to receive multiple channels of television content;
a second tuner configured to receive the multiple channels of television content;
a controller configured to:
receive a first channel from the first tuner;
output the first channel from the first tuner to a display;
set the second tuner to the first channel;
change the first tuner to one or more other channels;
output the one or more other channels to the display; and
notify a user of an end of a commercial in response to the detection of the end of the commercial by a processor; and
the processor configured to:
monitor the first channel from the second tuner for the end of the commercial; and
detect the end of the commercial on the first channel from the second tuner.

2. The data processing system of claim 1, wherein the display further comprises a television connected to the controller and configured to display the multiple channels of television content.

3. The data processing system of claim 1, further comprising a remote-control configured to send a signal to the controller indicating an initiation of the commercial.

4. The data processing system of claim 1, further comprising a television signal source connected to the first tuner and the second tuner.

5. The data processing system of claim 1, wherein the controller is further configured to change the first tuner to the first channel for display to the user in response to the detection of the end of the commercial.

6. The data processing system of claim 1, wherein the controller is further configured to receive an indication of an initiation of a commercial on the first channel before setting the second tuner to the first channel.

7. The data processing system of claim 1, wherein the controller is further configured to display the first channel from the second tuner in a picture-in-picture window while displaying the one or more other channels from the first tuner in a main window.

8. The data processing system of claim 7, wherein the controller is further configured to return the first channel to a full screen in response to the detection of the end of the commercial.

9. The data processing system of claim 1, wherein the controller is further configured to display the first channel from the second tuner in a picture-by-picture window while displaying the one or more other channels from the first tuner in a main window.

10. The data processing system of claim 1, wherein the controller is further configured to display the notification of the detection of the end of the commercial for a predetermined amount of time.

11. A method in a data processing system for controlling a television to assist returning to a television channel at an end of a commercial, comprising:
displaying a first channel with a first tuner;
setting a second tuner to the first channel;
changing the first tuner to one or more other channels;
monitoring the first channel from the second tuner for an end of a commercial;
detecting the end of the commercial on the first channel from the second tuner; and
notifying a user of the end of the commercial in response to the detection of the end of the commercial.

12. The method of claim 11, further comprising changing the first tuner to the first channel for display to the user in response to the detection of the end of the commercial.

13. The method of claim 12, further comprising displaying the first channel from the first tuner to the user on a television.

14. The method of claim 11, further comprising receiving an indication of an initiation of a commercial on the first channel before setting the second tuner to the first channel.

15. The method of claim 11, further comprising displaying the first channel from the second tuner in a picture-in-picture window while displaying the one or more other channels from the first tuner in a main window.

16. The method of claim 15, further comprising returning the first channel to a full screen in response to the detection of the end of the commercial.

17. The method of claim 11, further comprising displaying the first channel from the second tuner in a picture-by-picture window while displaying the one or more other channels from the first tuner in a main window.

18. The method of claim 11, further comprising displaying the notification of the detection of the end of the commercial for a predetermined amount of time.

19. A method in a data processing system for controlling a television to assist returning to a television channel at an end of a commercial, comprising:
automatically monitoring television content on a first channel for an end of a commercial while displaying a second channel different from the first channel to a user;
automatically detecting the end of the commercial on the first channel; and
providing notification of the end of the commercial on the first channel to the user in response to the automatic detection of the end of the commercial.

20. The method of claim 19, further comprising automatically changing the display to the user from the second channel to the first channel upon detection of the end of the commercial on the first channel.
